(19) United States
(12) Patent Application Publication
(10) Pub. No.: US 2005/0093261 A1
(43) Pub. Date: May 5, 2005

(54) System for coupling vehicle frame members to a steering column, and scooter including same

(76) Inventors: Chen-Hsueh Liao, Hsin Chu Hsien (TW); Hsueh-Hu Liao, Longhua Town (CN)

Correspondence Address: LAW OFFICES OF ERIC KARICH, 2807 ST. MARK DR., MANSFIELD, TX, 76063, US

(21) Appl. No.: 10/949,548

(22) Filed: Sep. 24, 2004

Related U.S. Application Data
(60) Provisional application No. 60/506,236, filed on Sep. 25, 2003.
(60) Provisional application No. 60/529,049, filed on Dec. 12, 2003.

(51) Int. Cl. B62M 1/00

(52) U.S. Cl. 280/87.041

(57) ABSTRACT

A coupling system for use in a vehicle having a steering column and a pair of frame members has a plurality of flexible members; a bracket adapted for coupling to the steering column of the vehicle, the bracket having first and second pivot points for pivotally coupling the pair of frame members of the vehicle to the bracket; and first and second flexible pivot points for coupling each of the frame members to the bracket, the first and second flexible pivot points including the plurality of flexible members.

### CROSS-REFERENCE TO RELATED APPLICATIONS

This application for a utility patent claims the benefit of U.S. Provisional Application No. 60/506,236, filed Sep. 25, 2003, and U.S. Provisional Application No. 60/529,049, filed Dec. 12, 2003. These previous applications are hereby incorporated by reference in their entirety.

### BACKGROUND OF THE INVENTION

1. Field of the Invention

This invention relates generally to scooter-type vehicles, and more particularly to a scooter-type vehicle having multiple frame members coupled to a steering column with a bracket that enables the frame members to pivot with respect to the steering column.

2. Description of Related Art

The well known scooter includes a footboard positioned between a front wheel and a rear wheel. A rotatable upright steering post with a steering handle is coupled to the front wheel. A user puts the scooter in motion by grasping the steering handle, resting one foot on the footboard, and pushing off against the ground with the other foot. The user steers the scooter by turning the front wheel via the steering handle and the steering post.

Dual footboard scooters with two footboards are also known in the art. In a typical dual footboard scooter, the two footboards are spaced apart and arranged substantially in parallel, and are attached to two frame members that extend rearwardly from a steering column through which the steering post passes. A rear wheel is attached to an underside of each of the two footboards. Having three wheels in contact with the ground, dual footboard scooters are far more stable at low speeds than two-wheeled scooters.

Examples of known dual footboard scooters are shown in Beleski, Jr., U.S. Pat. Nos. 6,220,612, and 6,499,750, which are hereby incorporated by reference in full.

### SUMMARY OF THE INVENTION

The present invention teaches certain benefits in construction and use which give rise to the objectives described below.

The present invention provides a coupling system for use in a vehicle having a steering column and a pair of frame members. The coupling system comprises a plurality of flexible members; a bracket adapted for coupling to the steering column of the vehicle, the bracket having first and second pivot points for pivotally coupling the pair of frame members of the vehicle to the bracket; and first and second flexible pivot points for coupling each of the frame members to the bracket, the first and second flexible pivot points including the plurality of flexible members.

A primary objective of the present invention is to provide a coupling system having advantages not taught by the prior art.

Another objective is to provide a coupling system that is simple and inexpensive to manufacture and assemble.

A further objective is to provide a coupling system with superior handling characteristics.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1A is a side elevation view of a three-wheeled scooter including a coupling system for coupling right and left members of a frame to a steering column;

FIG. 1B is a top plan view of the scooter of FIG. 1A;

FIG. 2 is a perspective view of the coupling system of FIGS. 1A and 1B;

FIG. 3 is an exploded view of the coupling system of FIG. 2;

FIG. 4A is a top plan view of the coupling system of FIG. 3 in assembly;

FIG. 4B is a side elevation view of the coupling system of FIG. 3 in assembly;

FIG. 5A is a side elevation view of the coupling system of FIGS. 1A and 1B wherein the right member of the frame is moved in a downward direction with respect to the steering column and the left member is moved in an upward direction with respect to the steering column;

FIG. 5B is a rear elevation view of a portion of the coupling system of FIGS. 1A and 1B wherein the right member of the frame is moved in a downward direction with respect to the steering column and the left member is moved in an upward direction with respect to the steering column as in FIG. 5A;

FIG. 6A is a front elevation view of the coupling system of FIGS. 1A and 1B wherein both the right member and the left member of the frame are twisted in a counterclockwise direction with respect to the steering column;

FIG. 6B is a rear elevation view of a portion of the coupling system of FIGS. 1A and 1B wherein both the right member and the left member of the frame are twisted in a counterclockwise direction with respect to the steering column as in FIG. 6A;

FIG. 7 is a perspective view of an alternative embodiment of the coupling system;

FIG. 8 is an exploded view thereof;

FIG. 9 is a sectional view thereof taken along line 9-9 in FIG. 7;

FIG. 10 is a side elevation view of the coupling system of FIG. 7 wherein the right member of the frame is moved in an upward direction with respect to the steering column and the left member is moved in a downward direction with respect to the steering column; and

FIG. 11 is a sectional view of a portion of the coupling system as shown in FIG. 9 when the right and left members are positioned as shown in FIG. 10.

### DETAILED DESCRIPTION OF THE INVENTION

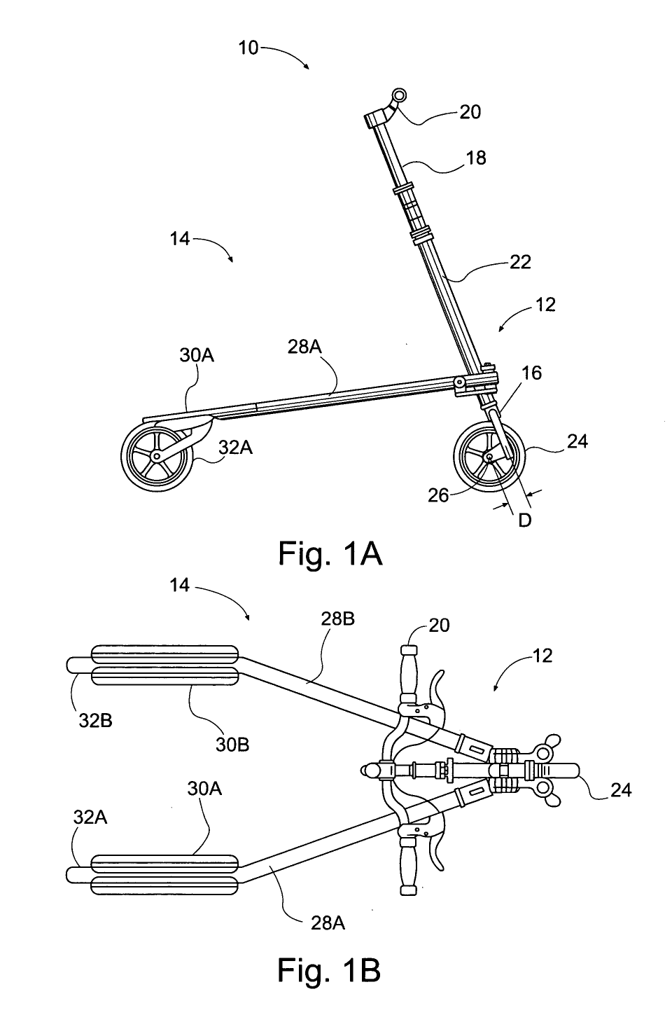

FIG. 1A is a side elevation view of a three-wheeled scooter 10 including a coupling system 12 for coupling right and left members of a frame 14 to a steering column 22. A front fork assembly 16 is connected to one end of a steering post 18, and a handlebar 20 is connected to an opposite end of the steering post 18. The steering post 18 passes through, and is rotatably coupled to, the steering column 22. The front fork assembly 16 includes two blades extending downward from the corresponding end the steering post 18. The two blades of the front fork assembly 16 connect to an axle 26 of a front wheel 24 on either side of the front wheel 24. A user of the scooter 10 (i.e., a rider) uses the handlebar 20 to rotate the steering post 18 within the steering column 22, thereby turning the front wheel 24 in order to steer the scooter 10. As indicated in FIG. 1A, the axle 26 of the front wheel 24 trails an axis of the steering column 22 (and the steering post 18) by a distance “D.”

In the embodiment of FIG. 1A, a footboard and a rear tire are connected to each of the right and left members of the frame 14. In FIG. 1A, a right member 28A of the frame 14 is visible, as is a right footboard 30A and a right rear tire 32A.

FIG. 1B is a top plan view of the scooter 10 of FIG. 1A. In FIG. 1B, a left member 28B of the frame 14 is visible, as is a left footboard 30B and a left rear tire 32B. As shown in FIG. 1B, the right member 28A and the left member 28B extend in a rearward direction from the steering column 22 (shown in FIG. 1), and the right footboard 30A and the left footboard 30B are arranged substantially parallel to one another and are spaced apart from one another.

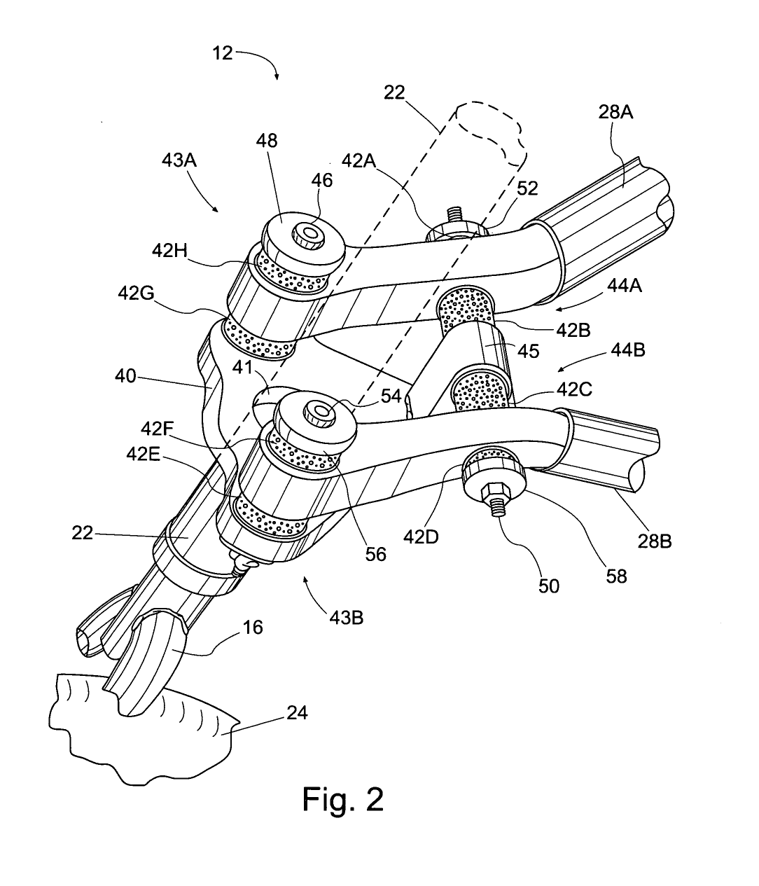

FIG. 2 is a perspective view of a first embodiment of the coupling system 12 of FIGS. 1A and 1B. In the embodiment of FIG. 2, a bracket 40 of the coupling system 12 is rigidly connected to the steering column 22, and ends of the right member 28A and the left member 28B are connected to the bracket 40 via first and second pivot points 43A and 43B, as well as first and second flexible pivot points 44A and 44B. These connections preferably include multiple flexible members 42A-42H of the coupling system 12. The right member 28A and the left member 28B extend in a rearward direction from the bracket 40.

In the embodiment of FIGS. 1A, 1B, and 2, the right member 28A and the left member 28B are coupled to one another only at the bracket 40 such that the frame 14 is open between the right footboard 30A and the left footboard 30B.

In the embodiment of FIG. 2, the steering column 22 substantially passes through a center aperture 41 of the bracket 40, and the bracket 40 has coupling members 44A and 44B positioned aft of the steering column 22. The end of the right member 28A is connected to the bracket 40 on the right side of the steering column 22 via flexible members 42G and 42H, and a portion of the right member 28A adjacent to the end is connected to the coupling member 44A via an inner pair of flexible members 42B and 42C that are each positioned to abut the bracket 40 and one of the pair of frame members 28A or 28B. The end of the left member 28B is connected to the bracket 40 on the left side of the steering column 22 via flexible members 42E and 42F, and a portion of the left member 28B adjacent to the end is connected to the coupling member 44B via flexible members 42C and 42D.

In the embodiment of FIG. 2, the end of the right member 28A has an upper surface and an opposed lower surface. The upper surface has a cavity for receiving a portion of the flexible member 42H, and the lower surface has a cavity for receiving a portion of the flexible member 42G. An upper surface of the bracket 40 has a similar cavity dimensioned to receive another portion of the flexible member 42G. A bolt 46 passes through holes in a cap 48, the flexible member 42H, the end of the right member 28A, the flexible member 42G, and the bracket 40, and flexibly connects the end of the right member 28A to the bracket 40.

The portion of the right member 28A adjacent to the end has two opposed side surfaces. An outermost one of the side surfaces has a cavity for receiving a portion of the flexible member 42A, and the other side surface has a cavity for receiving a portion of the flexible member 42B. A corresponding side surface of the bracket 40 has a cavity dimensioned to receive another portion of the flexible member 42B.

An elongate member 50 fits through both the bracket 40 and each of the pair of frame members 28A and 28B. In one embodiment, the elongate member 50 fits through a mounting portion 45 of the bracket 40. While we show a single elongate member 50 in the present embodiment, this is specifically defined to include embodiments that include a pair of elongate members that function as shown herein. In the present embodiment, the elongate member 50 is a bolt that passes through holes in a cap 52, the flexible member 42A, the portion of the right member 28A adjacent to the end, the flexible member 42B, and the bracket 40, and flexibly connects the portion of the right member 28A adjacent to the end to the bracket 40.

Like the end of the right member 28A, the end of the left member 28B has an upper surface and an opposed lower surface. The upper surface has a cavity for receiving a portion of the flexible member 42F, and the lower surface has a cavity for receiving a portion of the flexible member 42E. The upper surface of the bracket 40 has a cavity dimensioned to receive another portion of the flexible member 42E. A bolt 54 passes through holes in a cap 56, the flexible member 42F, the end of the left member 28B, the flexible member 42E, and the bracket 40, and flexibly connects the end of the left member 28B to the bracket 40.

Like the portion of the right member 28A adjacent to the end, the portion of the left member 28B adjacent to the end has two opposed side surfaces. An outermost one of the side surfaces has a cavity for receiving a portion of the flexible member 42D, and the other side surface has a cavity for receiving a portion of the flexible member 42C. A corresponding side surface of the bracket 40 has a cavity dimensioned to receive another portion of the flexible member 42C. The bolt 50 passes through holes in a cap 58, the flexible member 42D, the portion of the left member 28B adjacent to the end, the flexible member 42C, and the bracket 40.

The bracket 40 is preferably made of a rigid material, preferably a metal such as steel. As described in more detail below, the flexible members 42A-42H advantageously flex to allow limited movement of the right member 28A and the left member 28B with respect to the steering column 22. Accordingly, the flexible members 42A-42H are preferably made from an elastomeric material such as rubber or polyurethane.

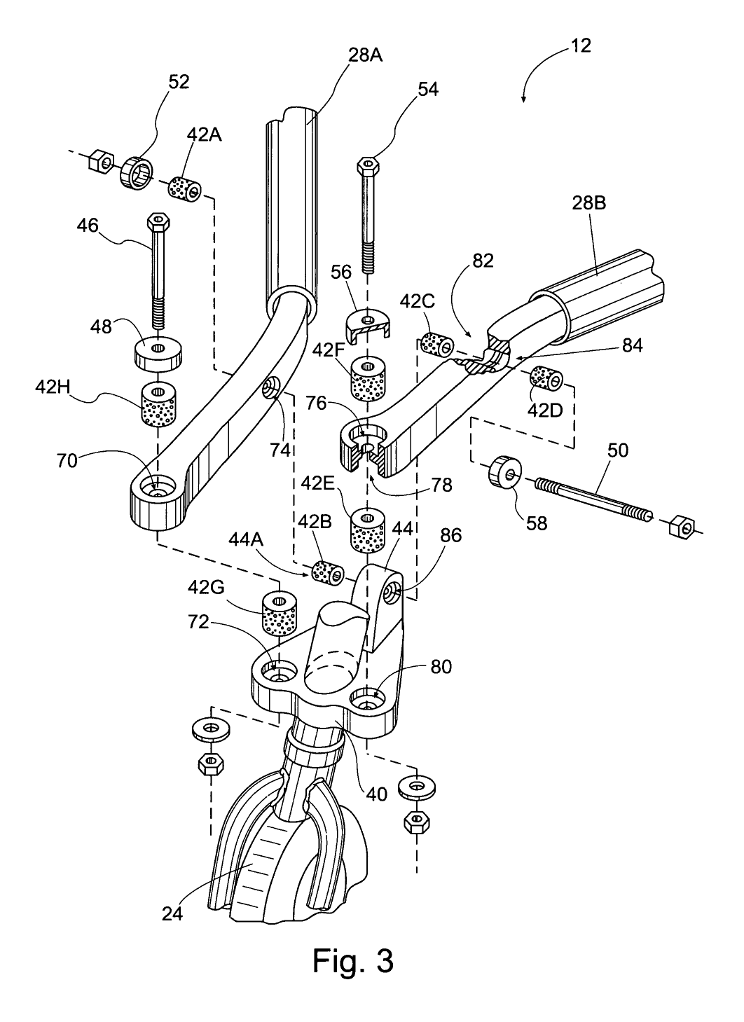

FIG. 3 is an exploded view of the coupling system 12 of FIG. 2. Evident in FIG. 3 is a cavity 70 in the upper surface of the end of the right member 28A. The cavity 70 is dimensioned to receive a portion of the flexible member 42H. The lower surface of the right member 28A has a similar cavity dimensioned to receiving a portion of the flexible member 42G. The upper surface of the bracket 40 has a cavity 72 dimensioned to receive another portion of the flexible member 42G. A hole for the bolt 46 in the end of the right member 28A passes through the cavity 70 and the similar cavity in the lower surface, and a hole for the bolt 46 in the bracket 40 passes through the cavity 72.

Also shown in FIG. 3 is a cavity 74 in an innermost side surface of the portion of the right member 28A adjacent to the end. The cavity 74 is dimensioned to receive a portion of the flexible member 42B. The corresponding side surface of the bracket 40 has a cavity dimensioned to receive another portion of the flexible member 42B. The outermost side surface has a similar cavity dimensioned to receive a portion of the flexible member 42A. A hole for the bolt 50 in the portion of the right member 28A adjacent to the end passes through the cavity 74 and the similar cavity in the outermost side surface, and a hole for the bolt 50 in the coupling member 44A passes through the cavity dimensioned to receive the other portion of the flexible member 42B.

FIG. 3 also shows a cavity 76 in the upper surface of the end of the left member 28B. The cavity 76 is dimensioned to receive a portion of the flexible member 42F. The lower surface of the left member 28B has a similar cavity 78 dimensioned to receiving a portion of the flexible member 42E. The upper surface of the bracket 40 has a cavity 80 dimensioned to receive another portion of the flexible member 42E. A hole for the bolt 54 in the end of the left member 28B passes through the cavities 76 and 78, and a hole for the bolt 54 in the bracket 40 passes through the cavity 80.

In FIG. 3 a cavity 82 exists in an innermost side surface of the portion of the left member 28B adjacent to the end. The cavity 82 is dimensioned to receive a portion of the flexible member 42C. The corresponding side surface of the bracket 40 has a cavity 86 dimensioned to receive another portion of the flexible member 42C. The outermost side surface has a similar cavity 84 dimensioned to receive a portion of the flexible member 42D. A hole for the bolt 50 in the portion of the left member 28B adjacent to the end passes through the cavities 82 and 84, and the hole for the bolt 50 in the coupling member 44B passes through the cavity 86.

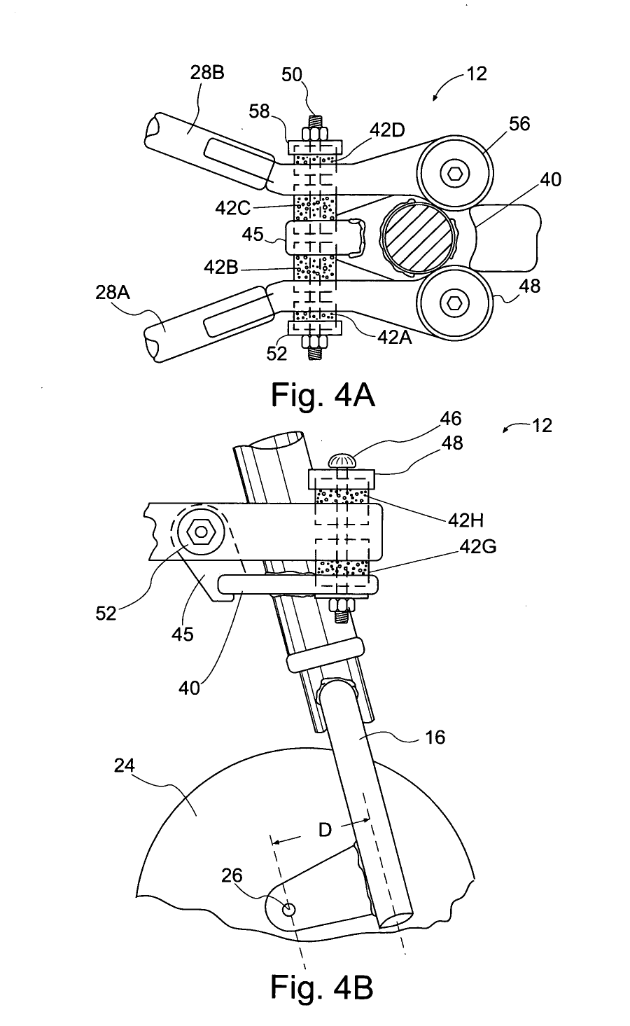

FIG. 4A is a top plan view of the coupling system 12 of FIG. 3 in assembly, and FIG. 4B is a side elevation view of the coupling system 12 of FIG. 3 in assembly.

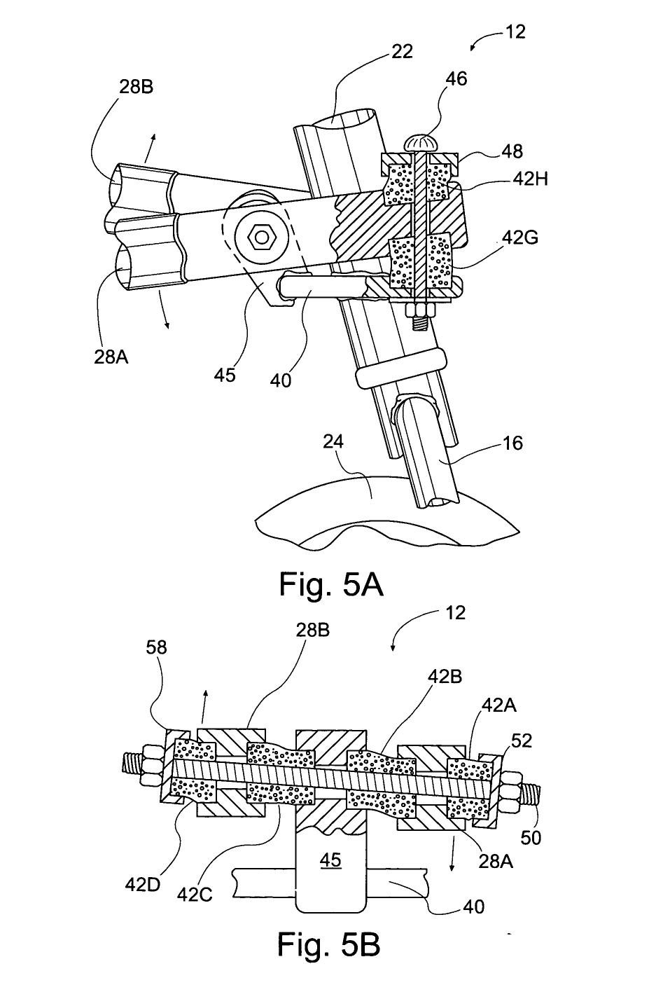

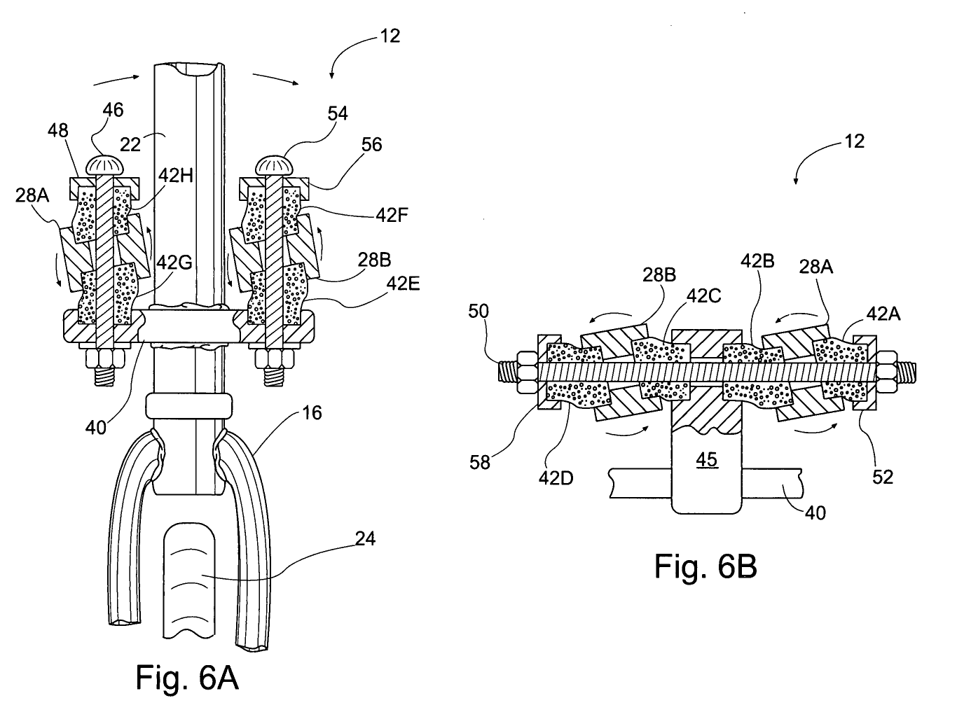

FIGS. 5A-5B and 6A-6B will now be used to illustrate how the flexible members 42A-42H of the coupling system 12 of FIGS. 1, 2, 3, 4A, and 4B advantageously flex to allow limited movement of the right member 28A and the left member 28B with respect to the steering column 22. Allowing limited movement of the right member 28A and the left member 28B with respect to the steering column 22 permits all three wheels of the scooter 10 of FIG. 1A to remain in contact with an underlying surface (i.e., the ground) even when the ground is not substantially level, and when the rider is turning the scooter 10 aggressively or at relatively high speed. As a result, the stability of the scooter 10 is increased.

FIG. 5A is a side elevation view of the coupling system 12 of FIGS. 1A and 1B wherein the right member 28A is moved in a downward direction with respect to the steering column 22 and the left member 28B is moved in an upward direction with respect to the steering column 22. This may occur, for example, when the ground under the scooter 10 (of FIG. 1) is not substantially level, or when the rider is turning the scooter 10 aggressively or at relatively high speed. In FIG. 5A, the flexible members 42G and 42H flex to allow movement of the right member 28A relative to the steering column 22. The flexible members 42G and 42H flex in a similar manner when the right member 28A is moved in an upward direction. The flexible members 42E and 42F (shown in FIG. 6A) corresponding to the left member 28B also flex in a similar manner, thereby allowing limited relative movement.

FIG. 5B is a rear elevation view of a portion of the coupling system 12 of FIGS. 1A and 1B wherein the right member 28A is moved in a downward direction with respect to the steering column 22 and the left member 28B is moved in an upward direction with respect to the steering column 22 as in FIG. 5A. In FIG. 5B, the flexible members 42A-42D flex to allow movement of the right member 28A and the left member 28B with respect to the steering column 22. The bracket 40, rigidly connected to the steering column 22 as described above, remains stationary in FIG. 5B. The flexible members 42A-42D flex in a similar manner when the right member 28A is moved in the upward direction and the left member 28B is moved in the downward direction.

FIG. 6A is a front elevation view of the coupling system 12 of FIGS. 1A and 1B wherein both the right member 28A and the left member 28B are twisted in a counterclockwise direction with respect to the steering column 22. This may occur, for example, when the ground under the scooter 10 (shown in FIGS. 1A and 1B) is not substantially level, or when the rider is turning the scooter 10 aggressively or at relatively high speed. In FIG. 6A, the flexible members 42E-42H flex to allow movement of the right member 28A and the left member 28B relative to the steering column 22. The flexible members 42E-42H flex in a similar manner when the right member 28A and the left member 28B are twisted in a clockwise direction.

FIG. 6B is a rear elevation view of a portion of the coupling system 12 of FIGS. 1A and 1B wherein both the right member 28A and the left member 28B are twisted in a counterclockwise direction with respect to the steering column 22 as in FIG. 6A. In FIG. 6B, the flexible members 42A-42D flex to allow movement of the right member 28A and the left member 28B with respect to the steering column 22. The bracket 40, rigidly connected to the steering column 22 as described above, remains stationary in FIG. 6B. The flexible members 42A-42D flex in a similar manner when both the right member 28A and the left member 28B are twisted about their axes in a counter-clockwise direction.

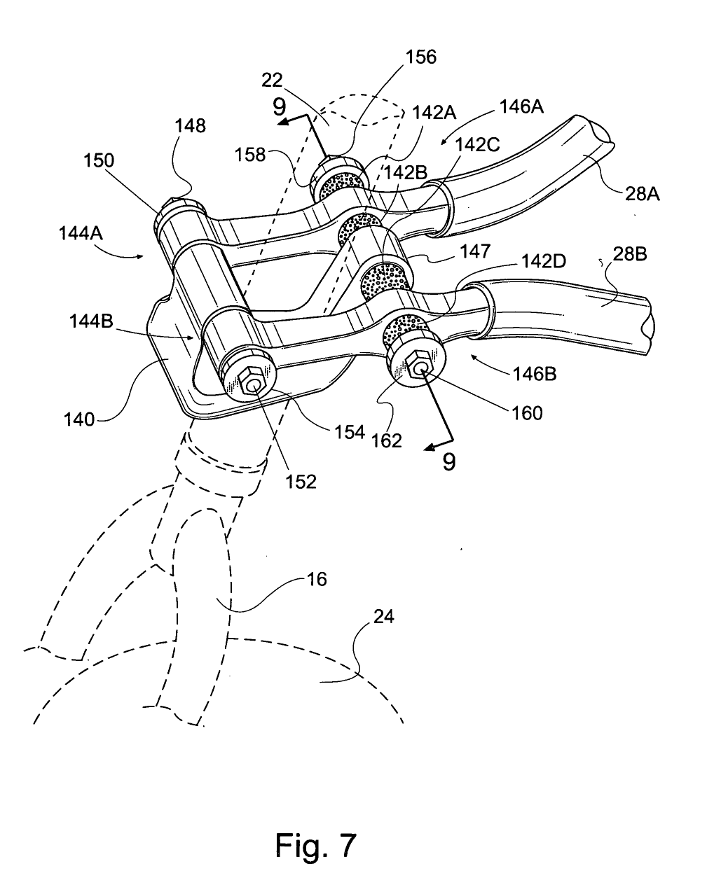

FIG. 7 is a perspective view of an alternative embodiment of the coupling system 12 of FIGS. 1A and 1B. As described above, the coupling system 12 similarly includes a bracket 140 that is adapted to be mounted on the steering column 22. In this embodiment, the bracket 140 includes first and second pivot points 144A and 144B adapted to engage the ends of the right member 28A and the left member 28B. The bracket 140 further includes first and second flexible pivot points 146A and 146B for flexibly connecting the right member 28A and the left member 28B to the bracket 140. The first and second flexible pivot points 146A and 146B include multiple flexible members 142A-142D, as described below.

The end of the right member 28A is pivotally connected to a first pivot point 144A (or “coupling member”), and the end of the left member 28B is pivotally connected to a second pivot point 144B (or “coupling member”). A portion of the right member 28A adjacent to the end is pivotally connected to a first flexible pivot point 146A (or “coupling member”) via flexible members 42A and 42B, and a portion of the left member 28B adjacent to the end is pivotally connected to a first flexible pivot point 146A (or “coupling member”) via flexible members 42C and 42D.

The end of the right member 28A has a hole passing therethrough from a right side surface to an opposed left side surface. As described in more detail below, the right side of the first coupling member 144A is threaded to receive a screw 148, and the screw 148 and a washer 150 rotatably connect the end of the right member 28A to the right side of the first coupling member 144A. Similarly, the end of the left member 28B has a hole passing therethrough from a right side surface to an opposed left side surface. As described in more detail below, the left side of the first coupling member 144 is threaded to receive a screw 152, and the screw 152 and a washer 154 rotatably connect the end of the left member 28B to the left side of the first coupling member 144B. The screws 148 and 152 may be, for example, machine screws, or socket screws fastened using a hexagonal Allen wrench. Other forms of fasteners and elongate members, as described above, may also be used.

The portion of the right member 28A adjacent to the end has a right side surface and an opposed left side surface. The right side surface has a cavity dimensioned to receive a portion of the flexible member 142A, and the left side surface has a cavity for receiving a portion of the flexible member 142B. A right side surface of the second coupling member 146B has a cavity dimensioned to receive another portion of the flexible member 142B. As described in more detail below, a screw 156 (e.g., a machine screw or socket screw) passes through a hole in a cap 158 and the flexible member 142A and flexibly connects the portion of the right member 28A adjacent to the end to the right side of the second coupling member 146B.

Similarly, the portion of the left member 28B adjacent to the end has a right side surface and an opposed left side surface. The left side surface has a cavity dimensioned to receive a portion of the flexible member 142D, and the right side surface has a cavity for receiving a portion of the flexible member 142C. A left side surface of the second coupling member 146B has a cavity dimensioned to receive another portion of the flexible member 142C. As described in more detail below, a fastener 160 such as a screw (e.g., a machine screw or socket screw, or nut as shown in FIG. 2, or other suitable fastening element known in to those skilled in the art) passes through a hole in a cap 162 and the flexible member 142D and flexibly connects the portion of the left member 28B adjacent to the end to the left side of the second coupling member 146B.

The bracket 140 is preferably made of a rigid material, preferably a metal such as steel. As described in more detail below, the flexible members 142A-142D advantageously flex to allow limited movement of the right member 28A and the left member 28B with respect to the steering column 22. Accordingly, the flexible members 142A-142D are preferably made from an elastomeric material such as rubber or polyurethane.

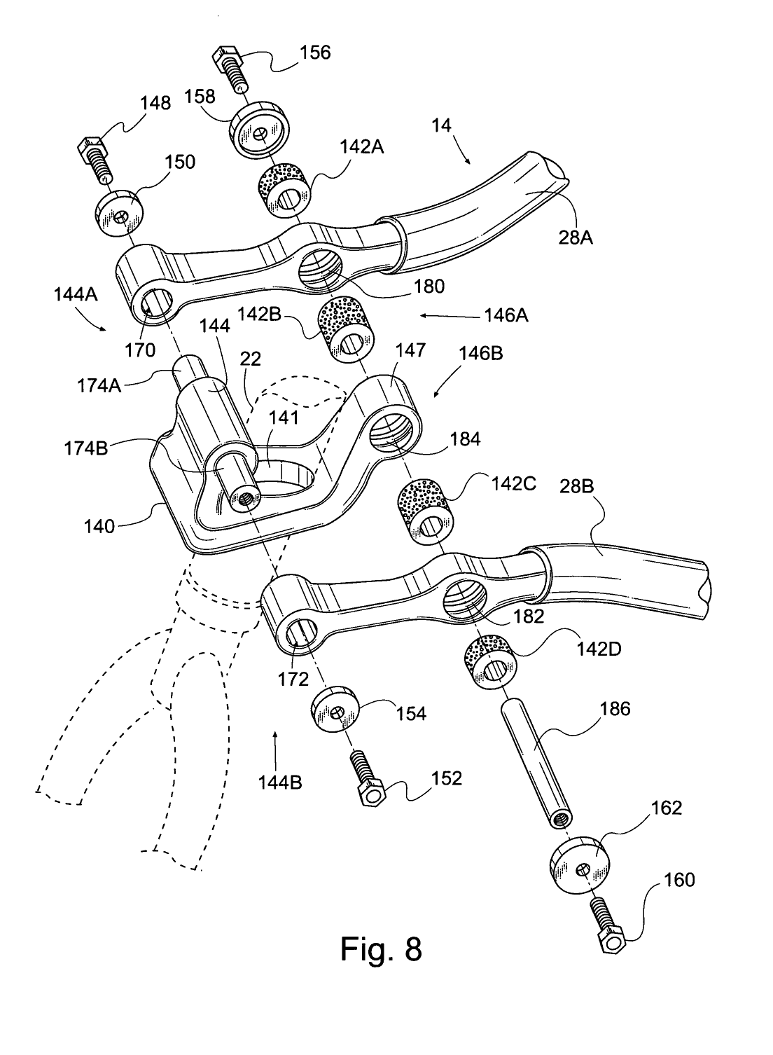

FIG. 8 is an exploded view of the coupling system 12 of FIG. 7, illustrating bracket 140 having a center hole 141. As described above, the steering column 22 passes through the center hole 141 of the bracket 140 so that the bracket 140 is rigidly connected to the steering column 22.

As shown in FIG. 8, the end of the right member 28A of the frame 14 has a hole 170 passing from the right side surface to the left side surface as described above. A pin 174A extends outwardly from the right side of the first coupling member 44A. The hole 170 in the end of the right member 28A is dimensioned to receive the pin 174A. The pin 174A is cylindrical, and has a threaded hole in an axial center of an outer end. In assembly, the end of the right member 28A is positioned relative to the bracket 140 such that the pin 174A of the first coupling member 144 passes through the hole 170 in the end of the right member 28A. The screw 148 passes through a hole in the washer 150 and threads into the threaded hole in the pin 174A. As a result, the end of the right member 28A is rotatably connected to the right side of the first coupling member 144.

Similarly, the end of the left member 28B of the frame 14 has a hole 172 passing from the right side surface to the left side surface as described above. A pin 174B extends outwardly from the left side of the first coupling member 144. The hole 172 in the of the left member 28B is dimensioned to receive the pin 174B. The pin 174B is cylindrical, and has a threaded hole in an axial center of an outer end. In assembly, the end of the left member 28B is positioned relative to the bracket 140 such that the pin 174B of the first coupling member 144 passes through the hole 172 in the end of the left member 28B. The screw 152 passes through a hole in the washer 154 and threads into the threaded hole in the pin 174B. As a result, the end of the left member 28B is rotatably connected to the left side of the first coupling member 144.

As described above, the portion of the right member 28A adjacent to the end has a cavity in the right side surface dimensioned to receive a portion of the flexible member 142A and a second cavity in the left side surface dimensioned to receive a portion of the flexible member 142B. In the embodiment of FIG. 8, the two cavities are in alignment, and an opening extends between the two cavities such that a ridge 180 separates the two cavities. The ridge 180 serves to keep the received portions of the flexible members 142A and 142B in place within the right member 28A.

Similarly, the portion of the left member 28B adjacent to the end has a cavity in the left side surface dimensioned to receive a portion of the flexible member 142D and a second cavity in the right side surface dimensioned to receive a portion of the flexible member 142C. The two cavities are in alignment, and an opening extends between the two cavities such that a ridge 182 separates the two cavities. The ridge 182 serves to keep the received portions of the flexible members 142D and 142C in place within the left member 28B.

As described above, the second coupling member 146B has a cavity in the right side surface dimensioned to receive the other portion of the flexible member 142B and a second cavity in the left side surface dimensioned to receive the other portion of the flexible member 142C. In the embodiment of FIG. 8, the two cavities are in alignment, and an opening extends between the two cavities such that a ridge 184 separates the two cavities. The ridge 184 serves to keep the received portions of the flexible members 142B and 142C in place within the second coupling member 146B.

In assembly, the portion of the flexible member 142A is positioned in the cavity in the right side surface of the portion of the right member 28A adjacent to the end, and the portion of the flexible member 142D is positioned in the cavity in the left side surface of the portion of the left member 28B adjacent to the end. The portions of the flexible member 142B are positioned in the respective cavities in the right member 28A and the second coupling member 146B, and the portions of the flexible member 142C are positioned in the respective cavities in the left member 28B and the second coupling member 146B.

A fastening system for flexibly connecting the portions of the right member 28A and the left member 28B adjacent to the ends to the second coupling member 146B includes pivot points 144A and 144B, and flexible pivot points 146A and 146B, as described above. In this embodiment, the bracket 140 includes a mounting portion 147 similar to the embodiment described above, and the elongate element is a cylindrical rod 186 having threaded axial holes at each end. Each of the flexible members 142A-142D has a hole substantially in a center and dimensioned to receive the rod 186. In general, the openings between the cavities in the portions of the right member 28A and the left member 28B adjacent to the ends, and in the second coupling member 146B, are dimensioned to receive the rod 186. More specifically, the openings are larger than the cross section of the rod 186 to allow the rod 186 to move within the openings.

In assembly, the rod 186 is inserted into the aligned holes in the flexible members 142A-142D.

The screw 156 passes through a hole in the cap 158 and threads into the threaded hole at one end of the rod 186, and the screw 160 passes through a hole in the cap 162 and threads into the threaded hole at opposite end of the rod 186. As a result, the portion of the right member 28A adjacent to the end is flexibly connected to the right side of the second coupling member 146B, and the portion of the left member 28B adjacent to the end is flexibly connected to the left side of the second coupling member 146B.

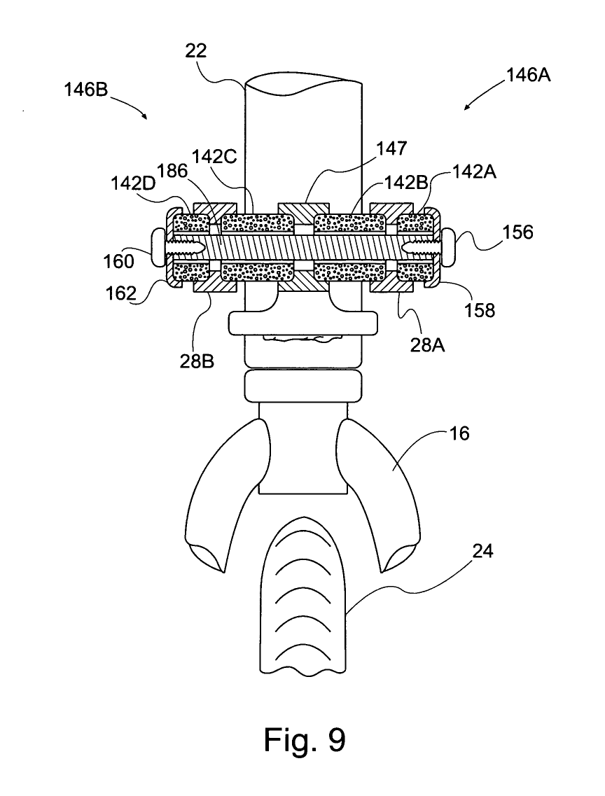

FIG. 9 is a rear elevation view of a portion of the coupling system 12, as cut along sectional lines 9-9 in FIG. 7 wherein the right member 28A and the left member 28B are similarly positioned with respect to the steering column 22. That is, the member 28A and the left member 28B are substantially even with one another, as expectedly occurs when the scooter 10 of FIGS. 1A and 1B moves in a straight line. In FIG. 9, the rod 186 is substantially horizontal and substantially perpendicular to the steering column 22.

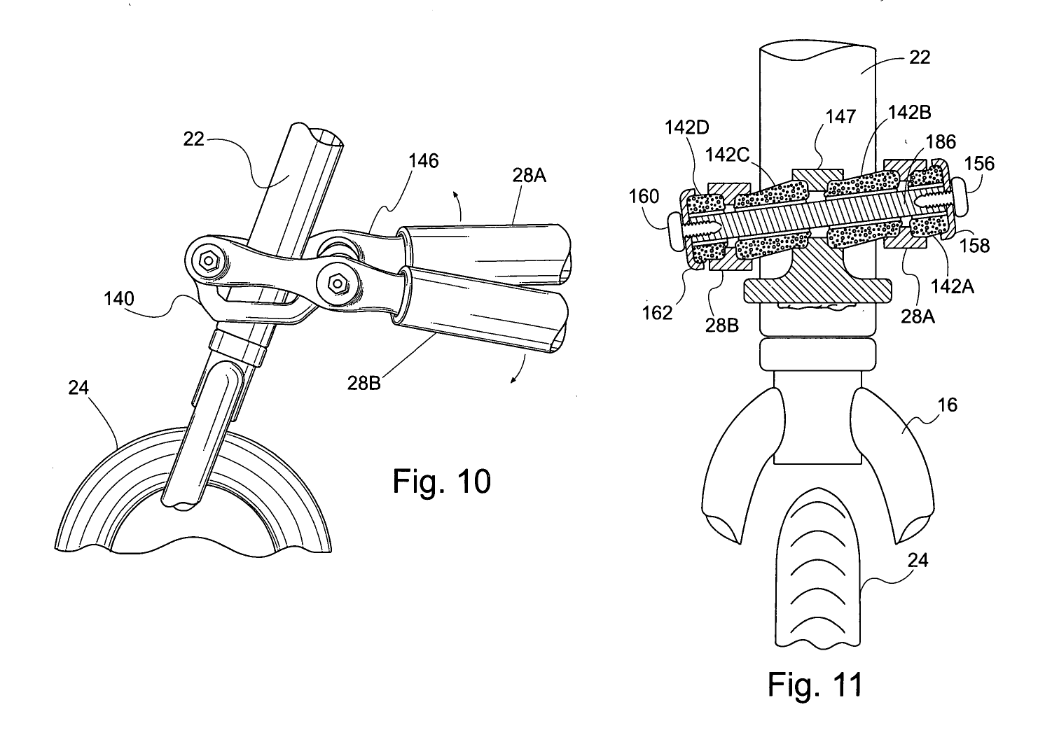

FIGS. 10 and 11 will now be used to illustrate how the flexible members 142A-142D of the coupling system 12 of FIG. 7 advantageously flex to allow limited movement of the right member 28A and the left member 28B with respect to the steering column 22. Allowing limited movement of the right member 28A and the left member 28B with respect to the steering column 22 permits all three wheels of the scooter 10 to remain in contact with an underlying surface (i.e., the ground) even when the ground is not substantially level, and when the rider is turning the scooter 10 aggressively or at relatively high speed. As a result, the stability of the scooter 10 is increased.

FIG. 10 is a side elevation view of the coupling system 12 of FIG. 7 wherein the right member 28A is moved in an upward direction with respect to the steering column 22 and the left member 28B is moved in a downward direction with respect to the steering column 22. This may occur, for example, when the ground under the scooter 10 is not substantially level, or when the rider is turning the scooter 10 aggressively or at relatively high speed. In FIG. 10, the bracket 140, rigidly connected to the steering column 22 as described above, remains stationary. The flexible members 142A and 142B, described above, flex to allow movement of the right member 28A relative to the steering column 22, and the flexible members 142C and 142D, also described above, flex to allow movement of the left member 28B relative to the steering column 22.

FIG. 11 is a rear elevation view of a portion of the coupling system 12 of FIG. 10. As described above, the flexible members 142A and 142B flex to allow movement of the right member 28A relative to the steering column 22, and the flexible members 142C and 142D flex to allow movement of the left member 28B relative to the steering column 22. In FIG. 11, as a result of the upward movement of the right member 28A and the downward movement of the left member 28B, the rod 186 is rotated in a counterclockwise direction from horizontal about the second coupling member 146B (shown in FIG. 8).

It is noted that the flexible members 142A-142D flex in a similar manner when the right member 28A is moved in a downward direction with respect to the steering column 22 and the left member 28B is moved in an upward direction with respect to the steering column 22.

While the invention has been described with reference to at least one preferred embodiment, it is to be clearly understood by those skilled in the art that the invention is not limited thereto. Rather, the scope of the invention is to be interpreted only in conjunction with the appended claims.

1. A coupling system for use in a vehicle having a steering column and a pair of frame members, the coupling system comprising:
a plurality of flexible members; and
a bracket adapted for coupling to the steering column of the vehicle, the bracket having:
first and second pivot points for pivotally coupling the pair of frame members of the vehicle to the bracket; and
first and second flexible pivot points for coupling each of the frame members to the bracket, the first and second flexible pivot points including the plurality of flexible members.

2. The coupling system as recited in claim 1, wherein first and second flexible pivot points include an elongate member that fits through both the bracket and each of the pair of frame members, and wherein the plurality of flexible members include an inner pair of flexible members that are each positioned to abut the bracket, the elongate member, and one of the pair of frame members.

3. The coupling system as recited in claim 1, wherein the bracket is adapted for rigid coupling to the steering column, and wherein the ends of the frame members are flexibly coupled to the bracket via the flexible members.

4. The coupling system as recited in claim 1, wherein the bracket comprises a hole passing therethrough substantially in a center of the bracket for receiving the steering column, and a pair of holes on either side of the hole for the steering column for receiving the pair of fasteners.

5. The coupling system as recited in claim 1, wherein the bracket comprises a coupling member positioned adjacent to the hole for the steering column, and wherein the coupling member extends from a surface of the bracket and is adapted to receive the at least one fastener for coupling the portions of each of the frame members adjacent to the ends to the bracket.

6. The coupling system as recited in claim 5, wherein the coupling member has at least one hole passing therethrough for receiving the at least one fastener for coupling the portions of each of the frame members adjacent to the ends to the bracket.

7. The coupling system as recited in claim 1, wherein the bracket comprises a substantially rigid material.

8. The coupling system as recited in claim 1, wherein the flexible members comprise an elastomeric material.

9. A scooter, comprising:
a steering column;
a pair of frame members each having an end;
a coupling system comprising a bracket and a plurality of flexible members, wherein the bracket is connected to the steering column, and wherein the ends of the frame members are connected to the bracket via the flexible members.

10. The scooter as recited in claim 9, wherein the flexible members allow limited movement of the frame members with respect to the steering column.

11. The scooter as recited in claim 9, wherein the bracket is rigidly connected to the steering column, and wherein the ends of the frame members are flexibly connected to the bracket via the flexible members.

12. The scooter as recited in claim 9, wherein the bracket comprises a hole passing therethrough substantially in a center of the bracket for receiving the steering column, and wherein the steering column passes through the hole.

13. The scooter as recited in claim 12, wherein the ends of the frame members are connected to the bracket on corresponding sides of the steering column.

14. The scooter as recited in claim 13, wherein the end of each of the frame members is connected to the bracket via a pair of the flexible members such that the end is interposed between the pair of the flexible members.

15. The scooter as recited in claim 12, wherein the bracket comprises a coupling member positioned adjacent to hole for the steering column, wherein the coupling member extends from a surface of the bracket, and wherein a portion of each of the frame members adjacent to the end is connected to the coupling member via a pair of the flexible members.

16. The scooter as recited in claim 15, wherein the portion of each of the frame members adjacent to the end is connected to the coupling member via a pair of the flexible members such that the portion of the frame member adjacent to the end is interposed between the pair of the flexible members.

17. A coupling system for use in a vehicle having a steering column and a pair of frame members, the coupling system comprising:
a bracket adapted for coupling to the steering column of the vehicle
first and second pivot points for pivotally coupling the pair of frame members of the vehicle to the bracket; and
first and second flexible pivot points for coupling each of the frame members to the bracket, the first and second flexible pivot points including an elongate member that fits through both the bracket and each of the pair of frame members, and an inner pair of flexible members that are each positioned to abut the bracket, the elongate member, and one of the pair of frame members.

18. The coupling system of claim 17 wherein each of the flexible pivot points further includes a fastener that fastens a flexible member against one of the frame members opposite the inner pair of flexible members.
